(19) United States
(12) Patent Application Publication
(10) Pub. No.: US 2024/0001456 A1
(43) Pub. Date: Jan. 4, 2024

(54) Mandrel Assembly for Use With a Rotary Tool

(71) Applicant: Robert Bosch GmbH, Stuttgart (DE)

(72) Inventors: Jeremy Rubens, Palatine, IL (US); Caitlyn Miklasz, Chicago, IL (US); Alexander Hills, Belvidere, IL (US)

(21) Appl. No.: 17/854,804

(22) Filed: Jun. 30, 2022

(51) Int. Cl. B23B 31/40

(52) U.S. Cl. CPC B23B 31/404

(57) ABSTRACT

A mandrel assembly may be used with a rotary power tool to provide a reliable and stable connection between the rotary tool and a tool accessory. The mandrel assembly provides a quick-connect/quick-release connection between the tool output shaft and the accessory via a clamping action. In particular, the mandrel assembly is operable to clamp the accessory between a clamping element formed on one end of the mandrel and a collar which surrounds the mandrel and is spring-biased toward the mandrel end.

### BACKGROUND

Hand held rotary tools typically include a tool housing designed to be easily held within a human hand. The housing contains an electric motor which is operable to drive a rotatable chuck of the rotary tool. A mandrel may be releasably coupled to the chuck so as to be rotatably driven by the rotary tool. In turn, an accessory may be releasably secured to the mandrel thereby enabling the rotary tool to rotatably drive the accessory. The accessory may be a cutting blade, a cut-off wheel, a polishing wheel, a grinding wheel, a sanding disc, or any other similar device.

Many types of mechanisms may be used to secure the accessory to the mandrel. In one example, a mandrel includes a base having a threaded aperture and a clamping screw that engages the aperture in order to clamp the accessory between the base and the clamping screw. In this example, a tool is required to tighten the clamping screw. In another example, an accessory is connected to the mandrel via a quick connection clamp that is operated via a lever provided on the tool for that purpose. In this example, the lever mechanism adds weight, complexity and cost to the tool. In both examples, with the accessory so clamped, rotation of the mandrel by the rotary tool causes rotation of the accessory thereby allowing the user to perform work on a workpiece.

Accordingly, it would be advantageous to provide a mandrel that can be used quickly and easily and does not require the use of an additional tool such as a screwdriver, or the use of a relatively small, separate component such as a clamping screw. In addition, it would be advantageous to provide a mandrel having a simple and easily operated mechanism.

### SUMMARY

A mandrel assembly is disclosed that may be used with a rotary power tool to provide a reliable and stable connection between the rotary tool and a tool accessory. The mandrel assembly provides a quick-connect/quick-release connection between the tool output shaft and the accessory via a clamping action. In particular, the mandrel assembly is operable to clamp the accessory between a clamping element formed on one end of the mandrel and a collar which surrounds the mandrel and is spring-biased toward the mandrel end.

The mandrel assembly 4 is manually transformable between a first configuration in which the accessory can be mounted on the collar or detached from the collar, and a second configuration in which the accessory may be fixed relative to the collar via a clamping force and engagement of the collar with the accessory. The configuration of the mandrel assembly is changed between the first and second configurations by movement of the collar relative to the mandrel in a predetermined motion. The predetermined motion is set by the shape of slots formed in the collar which are engaged by a radially protruding pin of the mandrel. In one exemplary embodiment, the slots of the mandrel have a rectilinear shape, and configuration change is performed manually by the user. In another exemplary embodiment, the slots of the mandrel have a curvilinear shape, and configuration change is performed automatically after initiation by the user.

In some aspects, a mandrel assembly includes a collar. The collar includes a collar first end, a collar second end that is opposite the first end, and a sidewall that extends between the collar first end and the collar second end. The sidewall includes an inner surface that defines a bore. The bore opens at the collar first end and the collar second end. The bore has a step change in diameter that defines a shoulder. The sidewall includes a slot that is spaced apart from the collar first end and the collar second end. The mandrel assembly includes a mandrel disposed in the bore. The mandrel includes a mandrel first end that protrudes from the collar first end and a mandrel second end that is opposite the mandrel first end. The mandrel first end has a mandrel clamping element. The mandrel second end protrudes from the collar second end. The mandrel includes a longitudinal axis that extends through the mandrel first end and the mandrel second end. In addition, the mandrel includes a pin that is disposed between the mandrel first end and the mandrel second end. The pin protrudes from the mandrel in a direction perpendicular to the longitudinal axis and extends into the slot. The mandrel assembly includes a retention washer fixed to the mandrel between the pin and the mandrel second end and a spring that surrounds the mandrel, the spring extending between the retention washer and the shoulder. The slot is configured to permit the mandrel to move relative to the collar in both rotation about the longitudinal axis and translation along the longitudinal axis.

In some embodiments, the slot is configured to permit the rotation to occur serially with respect to the translation.

In some embodiments, the slot is configured to permit the rotation and translation to occur simultaneously.

In some embodiments, the collar first end includes a collar end surface. The collar first end includes posts that protrude from the collar end surface in a direction parallel to the longitudinal axis. Each post has a post end face. In addition, the collar first end includes lands corresponding to portions of the collar end surface disposed between the posts. The slot includes a first slot portion that permits pin travel between a first location of the collar and a second location of the collar. The second location of the collar is closer to the collar first end than the first location of the collar. The slot includes a second slot portion that permits pin travel between the second location of the collar and a third location of the collar. The slot includes a third slot portion that permits pin travel between the third location of the collar and a fourth location of the collar. The third location of the collar is closer to the collar first end than the fourth location of the collar. The first location of the collar is closer to the collar first end than the fourth location of the collar. When the pin is in the first slot portion, the mandrel clamping element is aligned with the posts, and when the pin is in the second slot portion, the mandrel clamping element is aligned with the lands and the spring urges the mandrel clamping element toward the lands.

In some embodiments, when the pin is at the first location of the collar, the mandrel clamping element is aligned with the posts and abuts the end faces of the posts. When the pin is pin is at the second location of the collar, the mandrel clamping element is aligned with the posts and is axially spaced relative to the posts. When the pin is at the third location of the collar, the mandrel clamping element is aligned with the lands and is axially spaced apart relative to the lands, and when the pin is at the fourth location of the collar, the mandrel clamping element is aligned with the lands and abuts the lands.

In some embodiments, the third location of the collar is spaced apart from the second location of the collar along a circumferential direction of the collar, and when the pin is in the third slot portion, the mandrel is rotatable relative to the collar about the longitudinal axis.

In some embodiments, the first slot portion is linear and extends in a direction parallel to the longitudinal axis. The second slot portion is linear and extends in a direction parallel to the longitudinal axis. The second slot portion is spaced apart from the first slot portion along a circumference of the collar. The third slot portion is linear and extends in a direction perpendicular to the longitudinal axis.

In some embodiments, the third slot portion extends along an arc length of ninety degrees.

In some embodiments, the third slot portion extends along an arc length of less than 10 degrees.

In some embodiments, the first slot portion and the second slot portion are arcuate.

In some embodiments, upon an axial relative movement between the collar and the mandrel, the slot is configured to permit the mandrel to automatically move relative to the collar between a first position in which the mandrel clamping element is aligned with and abutting the end faces of the posts, and a second position in which the mandrel clamping element is aligned with the lands and urged toward the lands via the spring.

In some embodiments, relative movement between the collar and the mandrel in a direction parallel to the longitudinal axis results in rotation of the mandrel about the longitudinal axis.

In some embodiments, the slot extends through a thickness of the sidewall.

In some embodiments, the mandrel clamping element comprises a plate that extends in a plane that is perpendicular to the longitudinal axis, the plate having an irregular profile that defines a central hub and pair of arms that protrude from opposite sides of the hub.

In some aspects, a mandrel assembly includes a collar and a mandrel surrounded by the collar. The collar includes a collar first end, a collar second end that is opposite the first end, and a sidewall that extends between the collar first end and the collar second end. The sidewall includes an inner surface that defines a bore. The bore opens at the collar first end and the collar second end. The bore has a step change in diameter that defines a shoulder. The sidewall includes a slot that is spaced apart from the collar first end and the collar second end. The mandrel is disposed in the bore and includes a mandrel first end that protrudes from the collar first end, the mandrel first end having a mandrel clamping element. The mandrel includes a mandrel second end that is opposite the mandrel first end, the mandrel second end protruding from the collar second end. The mandrel includes a longitudinal axis that extends through the mandrel first end and the mandrel second end and a pin disposed between the mandrel first end and the mandrel second end. The pin protrudes from the mandrel in a direction perpendicular to the longitudinal axis and extends into the slot. The mandrel assembly includes a retention washer disposed on the mandrel between the pin and the mandrel second end and a spring that surrounds the mandrel. The spring extends between the retention washer and the shoulder. The collar first end includes a collar end surface and posts that protrude from the collar end surface in a direction parallel to the longitudinal axis. Each post has a post end face. The collar first end includes lands corresponding to portions of the collar end surface disposed between the posts. The slot is configured to permit the mandrel to move relative to the collar between an insertion position in which the mandrel clamping element is aligned with and abutting the end faces of the posts, and a clamping position in which the mandrel clamping element is aligned with the lands and the lands are urged toward the clamping element via the spring.

In some embodiments, an accessory is configured to be connected to the mandrel assembly, the accessory including a body having a central opening. The central opening has a profile, and at least a portion of the profile has a shape and dimensions that correspond to the shape, dimensions and spacing of the posts such that the collar first end can be inserted into the central opening in a tolerance fit.

In some embodiments, an accessory is configured to be connected to the mandrel assembly, wherein a portion of the accessory is clamped between the lands and the mandrel clamping element.

In some embodiments, an accessory is configured to be connected to the mandrel assembly. The mandrel clamping element comprises a plate that extends in a plane that is perpendicular to the longitudinal axis. The plate has an irregular profile that defines a central hub and arms that protrude from opposite sides of the hub. In addition, a portion of the accessory is clamped between the lands of the collar and the arms of the mandrel clamping element.

### BRIEF DESCRIPTIONS OF THE DRAWINGS

FIG. 1 is a perspective view of a mandrel assembly connected to the chuck of a rotary tool.

FIG. 2 is a perspective view of the mandrel assembly of FIG. 1.

FIG. 3 is an exploded view of the mandrel assembly of FIG. 1 and an accessory.

FIG. 4 is a cross-sectional view of the mandrel assembly of FIG. 1 as seen along line 4-4 of FIG. 2.

FIG. 5 is a cross-sectional view of the mandrel assembly of FIG. 1 as seen along line 55 of FIG. 2.

FIG. 6 is a perspective view of the collar of the mandrel assembly of FIG. 1.

FIG. 7 is a side view of the collar of the mandrel assembly of FIG. 1, where black circles are used to represent the first, second, third and fourth collar locations.

FIG. 8 is a perspective view of the mandrel assembly of FIG. 1 illustrating the pin in the first slot portion and in the first collar location whereby the mandrel clamping element is aligned with and abuts the collar posts.

FIG. 9 is a perspective view of the mandrel assembly of FIG. 1 illustrating the pin in the first slot portion and in the second collar location, and illustrating the mandrel clamping element aligned with the collar posts and at a maximum axial spacing from the collar posts.

FIG. 10 is a perspective view of the mandrel assembly of FIG. 1 illustrating the pin in the second slot portion and between the second and the third collar locations, and illustrating the mandrel clamping element mis-aligned with the collar posts and at a maximum axial spacing from the collar posts.

FIG. 11 is a perspective view of the mandrel assembly of FIG. 1 illustrating the pin in the third slot portion and in the third collar location, and illustrating the mandrel clamping element aligned with the collar lands and at a maximum axial spacing from the collar posts.

FIG. 12 is a perspective view of the mandrel assembly of FIG. 1 illustrating the pin in the third slot portion and between the third and the fourth collar locations, and illustrating the mandrel clamping element aligned with the collar lands and at a close axial spacing from the collar lands whereby the mandrel clamping element is disposed between the posts.

FIG. 13 is a perspective view of an alternative embodiment of the mandrel assembly.

FIG. 14 is a perspective view of the collar of the mandrel assembly of FIG. 13.

FIG. 15 is a side view of the collar of the mandrel assembly of FIG. 13, where black circles are used to represent the first, second, third, fourth, fifth and sixth collar locations.

FIG. 16 is a perspective view of the mandrel assembly of FIG. 13 showing the pin in the first slot portion and in the first collar location whereby the mandrel clamping element is aligned with and abuts the collar posts.

FIG. 17 is a perspective view of the mandrel assembly of FIG. 13 showing the pin in the same configuration as illustrated in FIG. 16, and also showing the accessory oriented for insertion onto the collar first end.

FIG. 18 is a perspective view of the mandrel assembly of FIG. 13 showing the pin in the same configuration as illustrated in FIG. 16, and also showing the accessory disposed on the collar first end.

FIG. 19 is a perspective view of the mandrel assembly of FIG. 13 illustrating the pin in, the second slot portion and in the third collar location, and illustrating the mandrel clamping element aligned with the collar posts and at a maximum axial spacing from the collar posts.

FIG. 20 is a perspective view of the mandrel assembly of FIG. 13 illustrating the pin in the third slot portion and in the fourth collar location, and illustrating the mandrel clamping element slightly mis-aligned with the collar posts and at a maximum axial spacing from the collar posts.

FIG. 21 is a perspective view of the mandrel assembly of FIG. 13 illustrating the pin in the fourth slot portion and between the fourth and fifth collar locations, and illustrating the mandrel clamping element mis-aligned with the collar posts and at an axial spacing that is less than maximum.

FIG. 22 is a perspective view of the mandrel assembly of FIG. 13 illustrating the pin in the fifth slot portion and in the sixth collar location, illustrating the mandrel clamping element aligned with and abutting the collar lands, and illustrating the accessory clamped between the mandrel clamping element and the collar first end.

### DESCRIPTION

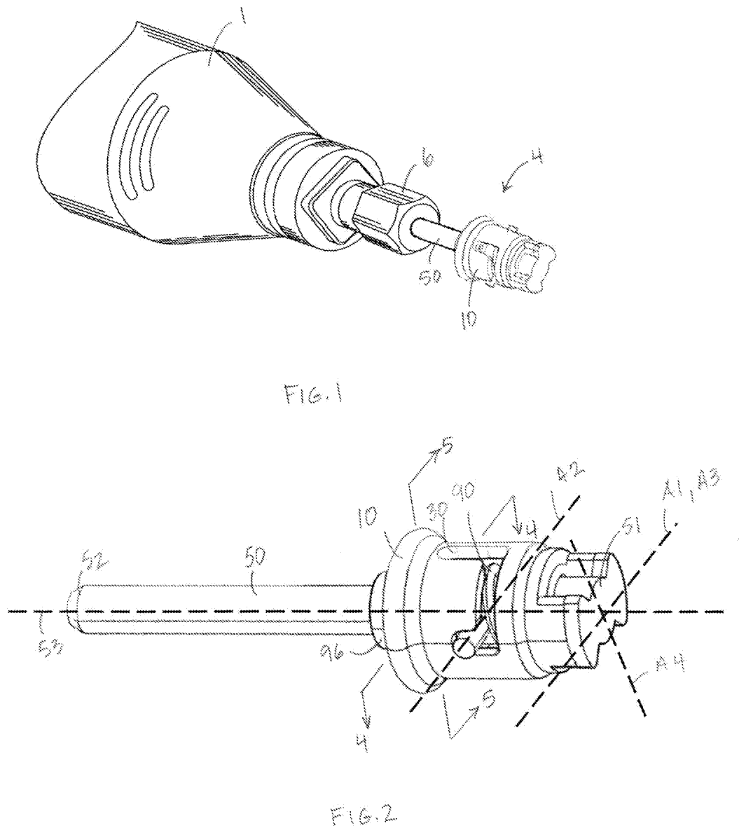

Referring to FIGS. 1-3, a mandrel assembly 4 may be used with a rotary tool 1 to provide a reliable and stable connection between the rotary tool 1 and a tool accessory 2. The rotary tool 1 includes an electric motor (not shown). An output shaft of the motor terminates in a chuck 6 configured to be coupled to a mandrel 50 of the mandrel assembly 4. The tool accessory 2 such as a cut-off wheel 200 is configured to be releasably connected to the mandrel assembly 4 via a quick-release clamping action, as discussed in detail below. Operation of the rotary tool 1 rotates the chuck, which in turn rotates the mandrel assembly 4, thereby imparting rotary movement to the cut-off wheel 200.

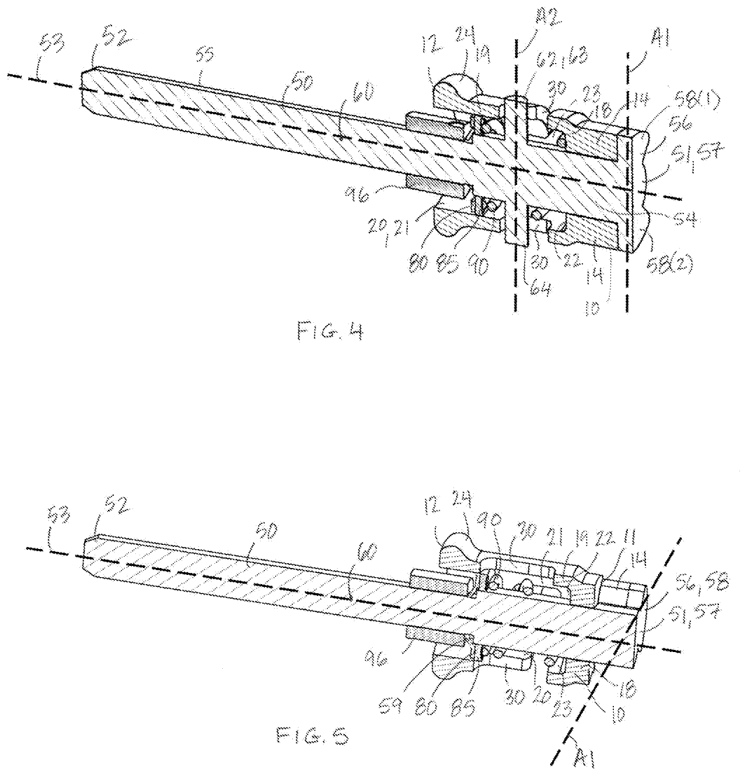

Referring to FIGS. 2-5, the mandrel assembly 4 includes the mandrel 50, a collar 10 having a bore 21 that receives the mandrel 50 therethrough, and a spring 90 that surrounds the mandrel 50 and is disposed in the bore 21. The spring 90 is retained in the bore 21 via a retention washer 80. The mandrel assembly 4 also includes a flat washer 85 disposed between the retention washer 80 and one end 92 of the spring 90, and a spacer 96 disposed on an opposed side of the retention washer 80 relative to the flat washer 86. The constituents of the mandrel assembly 4 will now be described in detail.

The mandrel 50 is a rigid, elongate and generally rod-shaped structure having a first end 51 and a second end 52 that is opposite the first end 51. The mandrel 50 includes a longitudinal axis 53 that extends through the mandrel first and second ends 51, 52 and corresponds to a rotational axis of the mandrel assembly 4. As used herein, the term “axially” refers to the longitudinal axis 53 or a direction parallel to the longitudinal axis 53 and the term “radially” refers to a direction along a radius that is perpendicular to and intersects the longitudinal axis 53.

The mandrel 50 is cylindrical and has a step change in diameter such that the mandrel first end 51 has a greater diameter than the mandrel second end 52. The mandrel 50 includes a mandrel shoulder 59 at the transition between the large diameter portion 54 and the small diameter portion 55. The mandrel shoulder 59 is located between the mandrel first end 51 and a midpoint 60 between the mandrel first and second ends 51, 52.

The mandrel first end 51 defines a rigid mandrel clamping element 56. The mandrel clamping element 56 is a plate that extends in a plane that is perpendicular to the longitudinal axis 53. The plate has an irregular profile that defines a central circular hub 57 and pair of arms 58 that protrude from opposite sides of the circular hub 57. Each arm 58 has the shape of a circular sector whereby the mandrel clamping element 56 has the appearance of a bow tie when viewed in a direction parallel to the longitudinal axis 53. The hub 57 is centered on the longitudinal axis 53, and the arms 58 are disposed on opposite sides of the hub 57 and are aligned along a first axis A1 that is that is perpendicular to and intersects the longitudinal axis 53. By this configuration, the mandrel 50 has a T-shape when viewed in a side view.

The mandrel second end 52 is configured to be received in the chuck 6 of the rotary tool 1. In the illustrated embodiment, the mandrel second end 52 is rounded to facilitate insertion into the chuck 6.

The mandrel 50 includes a pin 62 disposed between the mandrel shoulder 59 and the mandrel first end 51. The pin 62 extends through the mandrel 50 so as to intersect the longitudinal axis 53 and protrude from opposite lateral sides of the mandrel 50 in a direction perpendicular to the longitudinal axis 53. By this configuration, the pin 62 includes a first pin portion 63 that protrudes radially from a one lateral side of the mandrel 50 and a second pin portion 64 that protrudes radially from an opposite lateral side of the mandrel 50. The first and second pin portions 63, 64 are aligned along a second axis A2. The second axis A2 is perpendicular to and intersects the longitudinal axis 53 and is parallel to the first axis A1. By this configuration, the first pin portion 63 is axially aligned with the first arm 58(1) of the mandrel clamping element 56, and the second pin portion 64 is axially aligned with the second arm 58(2) of the mandrel clamping element 56. The first and second pin portions 63, 64 are received in respective slots 30 provided in the collar 10, as discussed in detail below.

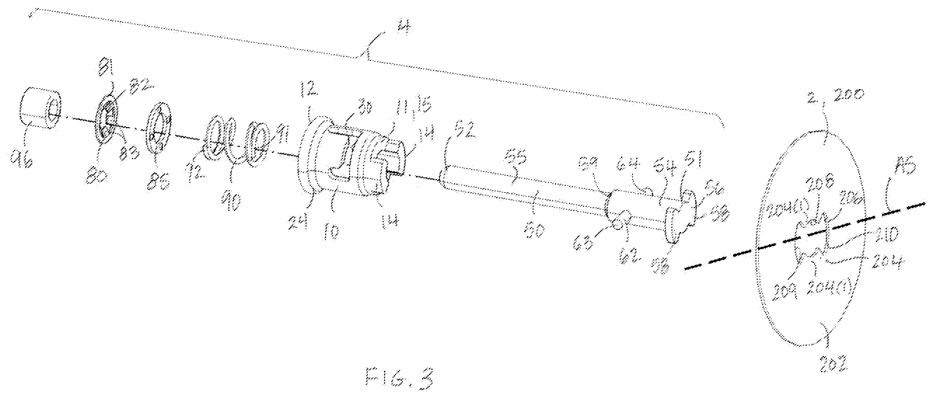

Referring to FIGS. 3-7, the collar 10 is a hollow, rigid cylinder that surrounds a portion of the mandrel 50. The collar 10 includes a sidewall 19 that extends between a collar first end 11 and a collar second end 12 that is opposite the collar first end 11. An inner surface 20 of the sidewall 19 defines the bore 21. The bore 21 is centered on the longitudinal axis 53 and has a diameter that is greater than that of the mandrel large diameter portion 54, whereby an annular gap 23 exists between the mandrel 50 and the sidewall inner surface 20. The gap 23 is dimensioned to receive the coil spring 90 that is positioned around the mandrel 50 as discussed below.

The collar first end 11 is closed by an end wall 18 except for a centrally-disposed opening 16 through which the mandrel 50 protrudes. The opening 16 is dimensioned to permit the mandrel 50 to rotate and translate freely with respect to the collar 10. An outer surface of the end wall 18 defines a first end surface 18(1) that is perpendicular to the longitudinal axis 53.

A pair of posts 14 protrude axially outward from the first end surface 18(1). The posts 14 are disposed on opposed sides of the opening 16 so as to be aligned along a third axis A3 that is that is perpendicular to and intersects the longitudinal axis 53. The posts 14 each have an arc shape when viewed in a direction parallel to the longitudinal axis 53. Portions of the first end surface 18(1) disposed between the posts 14 are referred to as lands 15. The lands 15 have the same shape and dimensions as the posts 14 and are recessed relative to the respective end faces 14(1) of the posts 14. Like the posts 14, the lands 15 are disposed on opposed sides of the opening 16 so as to be aligned along a fourth axis A4 that is that is perpendicular to and intersects the longitudinal axis 53, where fourth axis A4 is perpendicular to the third axis A3.

An inner surface of the end wall 18 defines a collar inner shoulder 22 that extends between the sidewall inner surface 20 and the central opening 16.

The collar second end 12 includes an enlarged rim 24 that protrudes radially outward and extends around the circumference of the sidewall 19. The enlarged rim 24 provides a gripping surface that is useful to assist a user in manually gripping the collar 10 and urging the collar 10 to translate axially relative to the mandrel 50, as discussed further below.

A pair of slots 30 are provided in the collar sidewall 19 between the collar first and second ends 11, 12. The slots 30 are on diametrically opposed sides of the sidewall 19. The slots 30 extend through the thickness of the sidewall 19 and communicate with the bore 21. The slots 30 are dimensioned to receive the pin 62 and to permit the pin 62 to translate therein. The slots 30 have an irregular shape that is designed to guide the pin 62 along a predetermined path that results in both translation and rotation of the mandrel 50 with respect to the collar 10. The slots 30 are described in detail below.

Referring to FIGS. 3-5, the mandrel 50 is retained within the collar 10 via the retention washer 80 that surrounds the mandrel small diameter portion 55 at a location closely adjacent to the mandrel shoulder 59. In the illustrated embodiment, an outer periphery of the retention washer 80 is a flat annulus 81 having an outer diameter than is less than a diameter d2 of the bore 21. An inner periphery 82 of the retention washer includes circumferentially spaced teeth 83. The teeth 83 are angled such that the radially innermost edges of the teeth 83 are non-coplanar with respect to the annulus 81. As a result, the teeth 83 engage an outer surface of the mandrel small diameter portion 55 so as to fix the retention washer 80 relative to the mandrel 50. The retention washer 80 is positioned relative to the mandrel 50 so that the annulus 81 is radially aligned with the mandrel shoulder 59.

In addition to the retention washer 80, the mandrel assembly 4 includes the flat washer 86 having an inner diameter that is greater than the diameter of the mandrel large diameter portion 54 and an outer diameter that is received within the bore 21 with a clearance fit. The flat washer 86 is disposed on the mandrel large diameter portion 54 so as to abut the retention washer annulus 81 and is disposed in the bore 21 between the retention washer 80 and collar inner shoulder 22.

The mandrel assembly 4 includes a coil spring 90 that is disposed in the gap 23 between the collar 10 and the mandrel 50. The spring 90 is coaxial with, and surrounds, the mandrel 50. A first end 91 of the spring 90 abuts the collar inner shoulder 22, and the opposite, second end 92 of the spring 90 abuts the flat washer 86, which in turn abuts the retention washer 80. The spring is dimensioned to be under compression in the mandrel assembly 4 so that the spring 90 biases the collar 10 toward the mandrel first end 51.

In addition, the mandrel assembly 4 includes a hollow cylindrical spacer 96 that surrounds the mandrel small diameter portion 55 and is positioned adjacent to the retention washer 80 on a side of the retention washer 80 that is opposite the flat washer 86. The spacer 96 functions to limit depth of insertion of the mandrel 50 into the chuck 6 of the rotary tool 1. In particular, when a user inserts the mandrel second end 52 into the chuck 6, physical interaction between the chuck 6 and the spacer 96 occurs thereby preventing the user from further advancing the mandrel assembly 4 into the chuck 6. The spacer 96 ensures that sufficient space is provided between the chuck 6 and the open second end 12 of the collar 10 when the mandrel assembly 4 is clamped to the chuck 6. Leaving sufficient space between these two components ensures that the collar 10 has enough space for axial travel so as to allow attachment and removal of the accessory 2 to and from the mandrel assembly 4.

Referring again to FIG. 3, the mandrel assembly 4 is operable to quickly and easily attach an accessory 2 to the rotary tool 1. The accessory 2, for example a cut off wheel 200, is secured to the mandrel first end 51 via a clamping action of the mandrel assembly 4. The cut-off wheel 200 includes a rigid hub 204 and a rigid disc portion 202 that surrounds the hub 204. The disc portion 202 defines an outer perimeter of the accessory 2, which in this embodiment provides a cutting surface. A centrally-located hub opening 206 is formed in, the hub 204.

In the illustrated embodiment, the hub opening 206 defines a circular central cut out 208, a first cut out 209 disposed on one side of the central cut out 208 and a second cut out 210 disposed on a side of the central cut out 208 opposite the first cut out 209. The first cut out 209 and the second cut out 210 each have the shape of a circular sector whereby the hub opening 206 has the appearance of a bow tie when the accessory 2 is viewed in top plan view. The cut outs 208, 209, 210 are aligned along a fifth axis A5. The central cut out 208 has a diameter that accommodates the hub 57 of the mandrel first end 51 in a tolerance fit, and the first and second cut outs 209, 210 are shaped and dimensioned to receive the collar posts 14 therethrough in a tolerance fit. By this configuration, portions 204(1) of the hub 204 adjacent to the central cut out 208 are axially aligned with and abut the lands 15 of the collar 10 when the accessory 2 is connected to the mandrel assembly 4, as discussed below.

In some embodiments, the cut-off wheel 200 is formed by molding the disc portion 202 from a combination of materials that include abrasive materials, resin materials, and one or more fiberglass mesh segments. Such a molding process is well-known in the art of manufacturing cut-off wheels.

Referring to FIGS. 6-8, the collar 10 includes the opposed slots 30 that are configured to guide the pin 62 of the mandrel 50 along a predetermined path that results in both translation and rotation of the mandrel 50 with respect to the collar 10. The slots 30 are identical, so only one slot 30 will be described in detail.

The slot 30 has a slot width that is dimensioned to receive the pin 62 in a clearance fit. In an exemplary first embodiment, the slot 30 has three linear slot portions 41, 42, 43 which extend between four predetermined locations 31, 32, 33, 34 (represented by filled circles in FIG. 7) of the collar 10. For example, the first slot portion 41 extends between the first collar location 31 and the second collar location 32, the second slot portion 42 extends between the second collar location 32 and the third collar location 33, and the third slot portion 43 extends between the third collar location 33 and the fourth collar location 34. The first, second and third slot portions 41, 42, 43 are serially connected such that the pin 62 may travel through the slot 30 between the first collar location 31 and the fourth collar location 34.

The first collar location 31 resides in a first plane P1 that is perpendicular to the longitudinal axis 53, and the second collar location 32 is disposed in a second plane P2 that is perpendicular to the longitudinal axis 53. The second plane P2 is axially spaced apart from the first plane P1, and the second plane P2 is disposed between the first plane P1 and the collar first end 11. The first collar location 31 is aligned with the second collar location 32 along an axis that is parallel to the longitudinal axis 53.

Like the second collar location 32, the third collar location 33 resides in the second plane P2. When viewed facing the collar first end 11, the third collar location 33 is spaced apart from the second collar location 32 along a circumference of the collar 10. For example, in some embodiments, the arc length of space between the second collar location 32 and the third collar location 33 (e.g., the arc length of the second slot portion 42) is in a range of 80 to 100 degrees. For example, in some embodiments, the arc length of space between the second collar location 32 and the third collar location 33 is 90 degrees.

The fourth collar location 34 resides in a third plane P3 that is perpendicular to the longitudinal axis 53. The third plane P3 is axially spaced apart from the first plane P1 and the second plane P2. In particular, the third plane is disposed between the first plane P1 and the collar second end 12, whereby the first plane P1 is disposed between the second plane P2 and the third plane P3. The fourth collar location 34 is aligned with the third collar location 33 along an axis that is parallel to the longitudinal axis 53.

By this configuration, the first and third slot portions 41, 43 are parallel to each other and perpendicular to the second slot portion 42. In addition, the axial dimension of the first slot portion 41 is less than that of the third slot portion 43. For example, in the illustrated embodiment, the axial dimension of the first slot portion 41 is about three times the diameter d1 of the pin 62, whereas the axial dimension of the third slot portion 43 is about six times the diameter d1 of the pin 62.

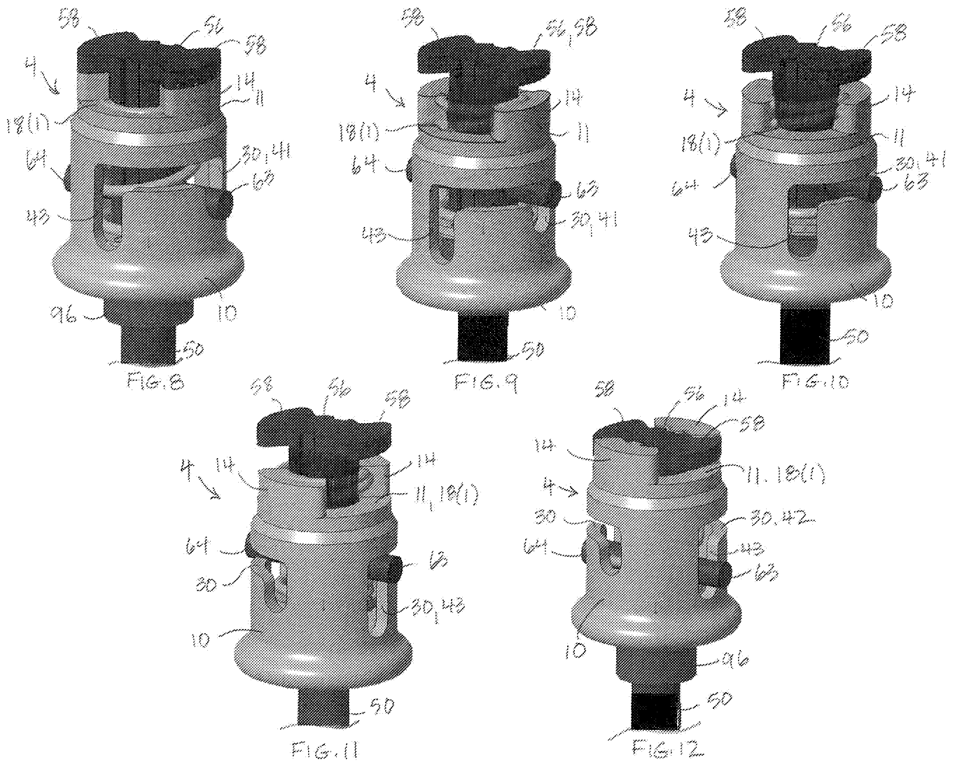

Referring to FIGS. 8-12, the mandrel assembly 4 is manually transformable between a first configuration (FIG. 8) in which the accessory 2 (i.e., the cut off wheel 200) can be mounted on the collar first end 11 or detached from the collar first end 11, and a second configuration (FIG. 12) in which the accessory 2 (not shown in FIG. 12) may be fixed relative to the collar first end 11. In the second configuration, the accessory 2 is retained on the collar first end 11 by clamping the accessory 2 between the collar first end surface 18(1) and the mandrel clamping element 56. In addition, the accessory 2 is prevented from relative rotation with respect to the collar 10 via engagement between the hub opening 206 of the accessory 2 and the posts 14 of the collar 10.

In the first configuration of the mandrel assembly 4, the first and second pin portions 63, 64 are disposed in the first slot portion 41 and in the first collar location 31 of a respective slot 30. When the first and second pin portions 63, 64 are disposed in the first collar location 31, the mandrel clamping element 56 is disposed at the collar first end 11. In particular, the first axis A1 is aligned with the third axis A3, whereby the arms 58 of the mandrel clamping element 56 are aligned with the posts 14. The first collar location 31 is positioned so that the arms 58 abut the respective end faces 14(1) of the posts 14. In this configuration, the collar end faces 14(1) are urged against the arms 58 by the coil spring 90. Because the arms 58 are aligned with and resting on the posts 14, the mandrel clamping element 56 and the posts 14 can be inserted into the hub opening 206 of the accessory 2.

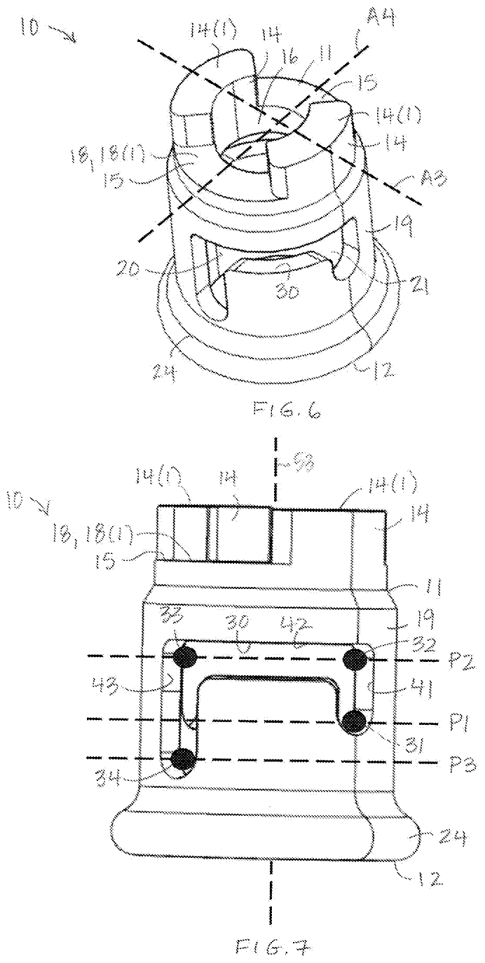

When transforming from the first configuration to the second configuration, the slots 30 guide the pin 62 along a predetermined path that results in both translation and rotation of the mandrel 50 with respect to the collar 10. Initially, the user moves the collar 10 toward the mandrel second end 52. As a result, the pin 62 moves axially along the first slot portion 41 to the second collar location 32 (FIG. 9). During movement between the first and second collar locations 31, 32, the mandrel 50 moves axially relative to the collar 10 such that the mandrel clamping element 56 moves away from the posts 14 while the first and third axes A1, A3 remain in axial alignment.

When the pin 62 is in the second collar location 32, the user rotates the collar 10 about the longitudinal axis 53 such that the pin 62 moves circumferentially along the second slot portion 42 from the second collar location 32 to the third collar location 33 (FIG. 10). As the pin 62 moves from the second collar location 32 to the third collar location 33, the mandrel clamping element 56 remains spaced apart from the collar 10 and the first axis A1 rotates into alignment with the four axis A4.

When the pin 62 is in the third collar location 33 (FIG. 11), the user releases the collar 10 allowing the collar 10 to move axially along the third slot portion 43 under the axial force of the coil spring 90 until the pin 62 rests in the collar fourth location 34 (FIG. 12). This configuration corresponds to the second configuration of the mandrel assembly 4.

In the second configuration of the mandrel assembly 4, the first and second pin portions 63, 64 are disposed in the third slot portion 43 and in the fourth collar location 34 of the respective slot 30. When the first and second pin portions 63, 64 are disposed in the fourth collar location 34, the mandrel clamping element 56 is disposed at the collar first end 11. In particular, the first axis A1 is aligned with the fourth axis A4, whereby the arms 58 of the mandrel clamping element 56 are aligned with the lands 15. The fourth collar location 34 is positioned so that the arms 58 abut the collar first end surface 18(1) (e.g., the arms 58 abut the lands 15). In this configuration, the lands 15 are urged toward the arms 58 by the coil spring 90. Because the arms 58 are aligned with and resting against the lands 15, the mandrel clamping element 56 is disposed between and intermeshed with the posts 14. In the second configuration of the mandrel assembly 4, the accessory 2 (e.g., the portions 204(1) of the hub 204 adjacent to the central cut out 208) may be clamped between the mandrel clamping element 56 and the lands 15 to join the accessory 2 to the mandrel 50. In this configuration, the accessory 2 is prevented from axial motion relative to the mandrel assembly 4 since it is clamped between the lands 15 of the collar and the arms 58 of the mandrel clamping element 56. In addition, the accessory 2 is prevented from rotational motion relative to the mandrel assembly since the posts 14 of the collar are received in the cut out portions 209, 210 of the accessory hub opening 206. The complimentary shapes of the posts 14 and the cut out portions 209, 210 cooperate to fix the rotational orientation of the accessory 2 relative to the mandrel 50.

To release the clamped accessory, the collar 10 is transformed from the second configuration to the first configuration by moving the pin 62 along the slots 30 from the fourth collar location 34 to the first collar location 31.

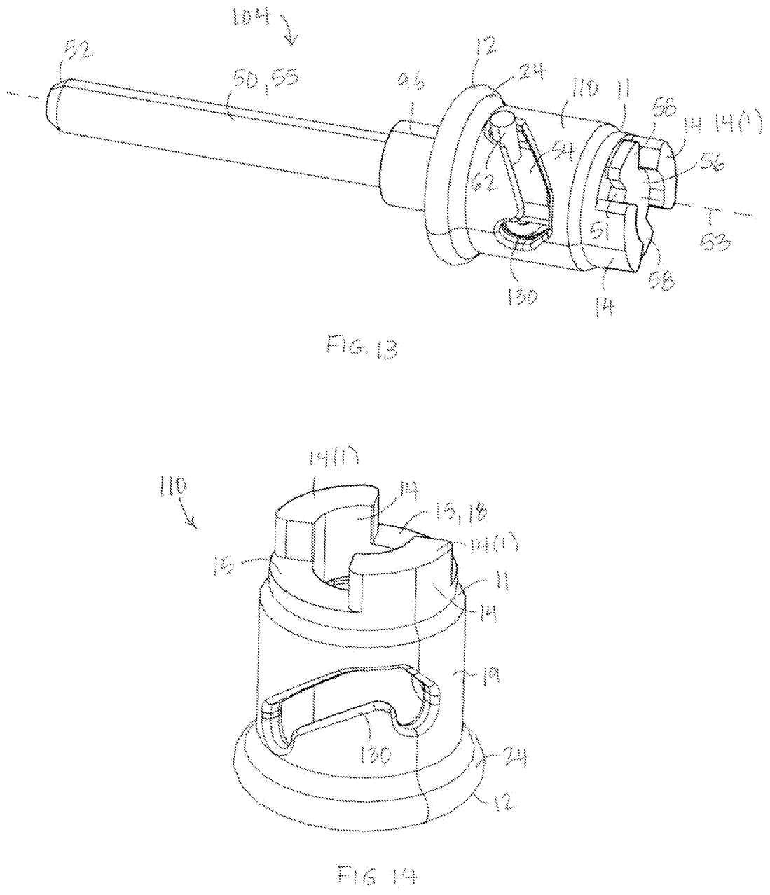

Referring to FIGS. 13-15, an exemplary second embodiment of a mandrel assembly 104 will now be described. The mandrel assembly 104 of FIGS. 13-14 is similar to the mandrel assembly 4 described above with respect to FIGS. 1-12, and common reference numbers are used to refer to common elements. In the mandrel assembly 104 of FIGS. 13-14, the collar 110 includes slots 130 having an alternative shape that permits mandrel assembly 104 to automatically transform between the first and second configurations upon application of an axial force to the collar 110.

The slot 130 has a slot width that is dimensioned to receive the pin 62 in a clearance fit. In the second embodiment, the slot 130 has five slot portions 141, 142, 143, 144, 145 which extend between six predetermined locations 131, 132, 133, 134, 135, 136 of the collar 110 (represented by filled circles in FIG. 15). For example, the first slot portion 141 extends between the first collar location 131 and the second collar location 132, the second slot portion 142 extends between the second collar location 132 and the third collar location 133, the third slot portion 143 extends between the third collar location 133 and the fourth collar location 134, the fourth slot portion 144 extends between the fourth collar location 134 and the fifth collar location 135 and the fifth slot portion 145 extends between the fifth collar location 135 and the sixth collar location 136. The first, second, third, fourth and fifth slot portions 141, 142, 143, 144, 145 are serially connected such that the pin 62 may travel through the slot 130 between the first collar location 131 and the sixth collar location 136.

The first collar location 131 resides in a first plane P101 that is perpendicular to the longitudinal axis 53, and the second collar location 132 is disposed in a second plane P102 that is perpendicular to the longitudinal axis 53. The second plane P102 is axially spaced apart from the first plane P101, and the second plane P102 is disposed between the first plane P101 and the collar first end 11. The first collar location 131 is aligned with the second collar location 132 along an axis that is parallel to the longitudinal axis 53. By this configuration, the first slot portion 141, which extends between the first and second collar locations 131, 132, is axially aligned and linear.

The third collar location 133 is disposed in a third plane P103 that is perpendicular to the longitudinal axis 53. The third plane P103 is axially spaced apart from the first and second planes P101, P102, and the third plane P103 is disposed between the second plane P102 and the collar first end 11. The third collar location 133 is offset from the second collar location 132 in a circumferential direction of the collar 110. In addition, the second slot portion 142, which extends between the second and third collar locations 132, 133 is slightly arcuate. For example, in some embodiments, the arc length of space between the second collar location 132 and the third collar location 133 (e.g., the arc length of the second slot portion 142) may be in a range of fifteen degrees to twenty-five degrees.

The fourth collar location 134 is disposed in the third plane P103. When viewed facing the collar first end 11, the fourth collar location 134 is slightly offset from the third collar location 133 along a circumference of the collar 110. For example, in some embodiments, the arc length of space between the third collar location 133 and the fourth collar location 134 (e.g., the arc length of the third slot portion 143) is in a range of two degrees to ten degrees. When viewed facing the collar first end 11, the fourth collar location 134 is spaced apart from the second collar location 132 along a circumference of the collar 110 a greater distance than that of the third collar location 133. In addition, the third slot portion 143, which extends between the third and fourth collar locations 133, 134 is linear.

The fifth collar location 135 resides in the first plane P101, or a parallel plane that is closely adjacent to the first plane P101. The fifth collar location 135 is offset from the fourth collar location 134 in a circumferential direction of the collar 110. When viewed facing the collar first end 11, the fifth collar location 135 is spaced apart from the fourth collar location 134 along a circumference of the collar 110 a greater distance than that of the third collar location 133. In addition, the fourth slot portion 144, which extends between the fourth and fifth collar locations 134, 135 is slightly arcuate. For example, in some embodiments, the arc length of space between the fourth collar location 134 and the fifth collar location 135 (e.g., the arc length of the fourth slot portion 144) may be in a range of fifty-five degrees to seventy-five degrees.

The sixth collar location 136 resides in a fourth plane P104 that is perpendicular to the longitudinal axis 53. The fourth plane P104 is axially spaced apart from the first plane P101, and the fourth plane P102 is disposed between the first plane P101 and the collar second end 12. The sixth collar location 136 is aligned with the fifth collar location 135 along an axis that is parallel to the longitudinal axis 53. By this configuration, the fifth slot portion 145, which extends between the fifth and sixth collar locations 135, 136, is axially aligned and linear.

By this configuration, the first and fifth slot portions 141, 145 are parallel to each other and perpendicular to the third slot portion 143. In addition, the axial dimension of the first slot portion 141 is approximately the same as that of the fifth slot portion 145. For example, in the illustrated embodiment, the axial dimensions of the first and fifth slot portions 141, 145 are about twice the diameter d1 of the pin 62.

In addition, when viewed facing the collar first end 11, the first and second collar locations 131, 132 are spaced apart from the fifth and sixth collar locations 135, 136 along a circumference of the collar 110. For example, in some embodiments, the arc length of space between the first slot portion 141, which includes the first and second collar locations 131, 132, and the fifth slot portion 145, which includes the fifth and sixth collar locations 135, 136, is in a range of 80 to 100 degrees. For example, in some embodiments, the arc length of space between the first slot portion 141 and the fifth slot portion 145 is 90 degrees.

Referring to FIGS. 16-22, the mandrel assembly 104 is transformable between a first configuration (FIG. 16) in which the accessory 2 (i.e., the cut off wheel 200) can be mounted on the collar first end 11 or detached from the collar first end 11, and a second configuration (FIG. 22) in which the accessory 2, for example cutting wheel 200, may be fixed relative to the collar first end 11. In the second configuration, the accessory 2 is retained on the collar first end 11 by clamping the accessory 2 between the collar first end surface 18(1) (e.g., the lands 15) and the mandrel clamping element 56. In addition, the accessory 2 is prevented from relative rotation with respect to the collar 110 via engagement between the hub opening 206 of the accessory 2 and the posts 14 of the collar 110.

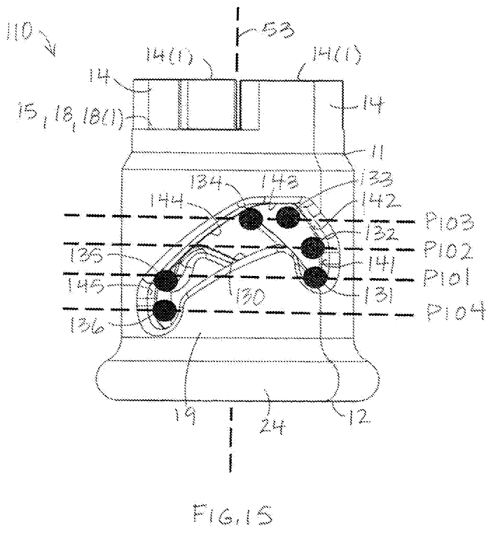

In the first configuration of the mandrel assembly 104, the first and second pin portions 63, 64 are disposed in the first slot portion 141 and in the first collar location 131 of a respective slot 130. When the first and second pin portions 63, 64 are disposed in the first collar location 131, the mandrel clamping element 56 is disposed at the collar first end 11. In particular, the first axis A1 is aligned with the third axis A3, whereby the anus 58 of the mandrel clamping element 56 are aligned with the posts 14. The first collar location 131 is positioned so that the arms 58 abut the respective end faces 14(1) of the posts 14 and the collar 100 is urged against the mandrel clamping element 56 by the coil spring 90. Because the arms 58 of the mandrel clamping element 56 are aligned with and resting against the posts 14, the mandrel clamping element 56 and the posts 14 can be inserted into the hub opening 206 of the accessory 2 (FIGS. 17 and 18).

When transforming from the first configuration to the second configuration, the slots 130 guide the pin 62 along a predetermined path that results in both translation and rotation of the mandrel 50 with respect to the collar 110. Initially, the user moves the collar 110 toward the mandrel second end 52. As a result, the pin 62 moves axially along the first slot portion 141 to the second collar location 132. During movement between the first and second collar locations 131, 132, the mandrel 50 moves axially relative to the collar 110 such that the mandrel clamping element 56 moves away from the posts 14 while the first and third axes A1, A3 remain in axial alignment.

When the pin 62 is in the second collar location 132, the axial force of the spring 90 causes the collar 110 to move toward the mandrel first end 51. As a result, the pin 62 moves along the second slot portion 144 to the third collar location 133 (FIG. 19). During movement between the second and third collar locations 132, 133, the mandrel 50 continues to move axially relative to the collar 110 such that the mandrel clamping element 56 moves still further away from the posts 14. In addition, the circumferential movement of the pin 62 causes the mandrel 50 to rotate relative to the collar 110. As previously discussed, the second slot portion 142 may permit a rotation in a range of fifteen degrees to twenty-five degrees.

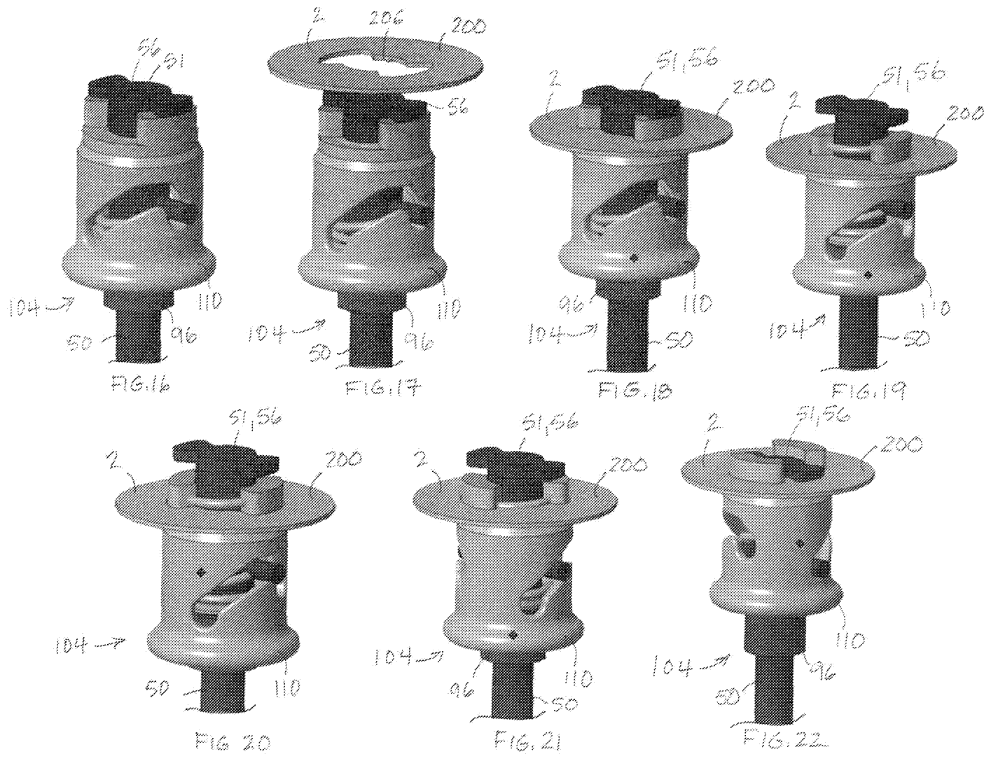

When the pin 62 is in the third collar location 133, the axial force of the spring 90 urges the collar 110 toward the mandrel first end 51, and rotational momentum urges the collar 110 to continue rotation relative to the mandrel 50. As a result, the pin 62 moves along the third slot portion 143 to the fourth collar location 134 (FIG. 20) and moves along the fourth slot portion 144 (FIG. 21) to the fifth collar location 135, during which the mandrel moves axially and also rotates about the longitudinal axis 53. As previously discussed, the third slot portion 143 may permit a rotation in a range of two degrees to ten degrees and the fourth slot portion 144 may permit a rotation in a range of fifty-five degrees to seventy-five degrees. As the pin 62 moves from the fourth collar location 134 to the fifth collar location 135, although the mandrel clamping element 56 moves toward the collar first end surface 18(1), the mandrel clamping element remains spaced apart from the collar first end surface 18(1). In addition, the first axis A1 rotates into alignment with the fourth axis A4.

When the pin 62 is in the fifth collar location 135, the collar 110 moves axially along the fifth slot portion 145 under the axial force of the coil spring 90 until the pin 62 rests in the sixth collar location 136 (FIG. 22). This configuration corresponds to the second configuration of the mandrel assembly 4.

The shape of the slots 130, which are generally curved toward the collar first end 11 between the first and third collar locations 131, 133 and generally curved away from the collar first end 11 between the third and sixth collar locations 133, 136 permits the pin 62 to be guided automatically between the first and second configurations under the axial force of the spring 90. The term “automatically” is used here since following the initial movement of the collar 110 by the user to displace the pin 62 from the first collar location 131, the collar 100 is moves independently and without further user input, to the second configuration.

In the second configuration of the mandrel assembly 104, the first and second pin portions 63, 64 are disposed in the fifth slot portion 145 and in the sixth collar location 136 of the respective slot 130. When the first and second pin portions 63, 64 are disposed in the sixth collar location 136, the mandrel clamping element 56 is disposed at the collar first end 11. In particular, the first axis A1 is aligned with the fourth axis A4, whereby the arms 58 of the mandrel clamping element 56 are aligned with the lands 15. The sixth collar location 136 is positioned so that the arms 58 abut the collar first end surface 18(1) (e.g., the arms 58 abut the lands 15) and are urged against the lands 15 by the coil spring 90. Because the arms 58 of the mandrel clamping element 56 are aligned with and resting on the lands 15, the mandrel clamping element 56 is disposed between and loosely intermeshed with the posts 14. In the second configuration of the mandrel assembly 104, portions 204(1) of the hub 204 of the accessory 2 may be clamped between the mandrel clamping element 56 and the lands 15 to join the accessory 2 to the mandrel 50.

To release the clamped accessory, the collar 110 is transformed from the second configuration to the first configuration by moving the pin 62 along the slots 130 from the sixth collar location 136 to the first collar location 131.

As described above, a mandrel assembly 4, 104 is disclosed that allows an accessory 2 to be quickly and conveniently coupled to the mandrel assembly 4, 104 without the need for an additional tool such as a screw driver. Likewise, by reversing the above-described actions, the accessory 2 may be quickly and conveniently decoupled from the mandrel assembly 4, 104. Therefore, the mandrel assembly 4, 104 may be conveniently used to connect numerous interchangeable accessories such as cut-off wheels, polishing wheels, grinding wheels, sanding discs, or similar articles of manufacture to the rotary tool 1.

In the illustrated embodiment, both the mandrel 50 and the collar 10, 110 are formed of metal such as steel. However, depending on the requirements of the specific application, the mandrel 50 may be formed of a different material than the collar 10, 110. In some embodiments, the mandrel 50 and the collar 10, 110 may be formed of alternative materials such as high strength polymers as determined by the requirements of the application.

In the illustrated embodiment, the collar 10 includes a pair of slots 30, 130 disposed on diametrically opposed sides of the sidewall 19. The collar is not limited to this configuration. For example, in some embodiments, the collar includes a single slot.

In the illustrated embodiment, the slots 30, 130 extend through the thickness of the collar sidewall 19. However, the slots 30, 130 are not limited to this configuration. For example, in some embodiments, the slots 13, 130 are partial thickness slots that are formed on an inner surface 20 of the sidewall 19. In such embodiments, the slots 30, 130 are not visible to the user.

Selective illustrative embodiments of mandrel assembly for a power tool are described above in some detail. It should be understood that only structures considered necessary for clarifying the mandrel assembly have been described herein. Other conventional structures, and those of ancillary and auxiliary components of the mandrel assembly, power tool and accessory are assumed to be known and understood by those skilled in the art. Moreover, while working examples of the mandrel assembly have been described above, the mandrel assemblies are not limited to the working examples described above, but various design alterations may be carried out without departing from the device as set forth in the claims.

What is claimed is:

1. A mandrel assembly, comprising:
a collar including
a collar first end,
a collar second end that is opposite the first end, and
a sidewall that extends between the collar first end and the collar second end, the sidewall including an inner surface that defines a bore, the bore opening at the collar first end and the collar second end, the bore having a step change in diameter that defines a shoulder, the sidewall including a slot that is spaced apart from the collar first end and the collar second end;
a mandrel disposed in the bore, the mandrel including
a mandrel first end that protrudes from the collar first end, the mandrel first end having a mandrel clamping element,
a mandrel second end that is opposite the mandrel first end, the mandrel second end protruding from the collar second end,
a longitudinal axis that extends through the mandrel first end and the mandrel second end, and
a pin disposed between the mandrel first end and the mandrel second end, the pin protruding from the mandrel in a direction perpendicular to the longitudinal axis and extending into the slot;
a retention washer fixed to the mandrel between the pin and the mandrel second end; and
a spring that surrounds the mandrel, the spring extending between the retention washer and the shoulder,
wherein
the slot is configured to permit the mandrel to move relative to the collar in both rotation about the longitudinal axis and translation along the longitudinal axis.

2. The mandrel assembly of claim 1, wherein the slot is configured to permit the rotational movement to occur serially with respect to the translational movement.

3. The mandrel assembly of claim 1, wherein the slot is configured to permit the rotational movement and the translational movement to occur simultaneously.

4. The mandrel assembly of claim 1, wherein
the collar first end includes
a collar end surface,
posts that protrude from the collar end surface in a direction parallel to the longitudinal axis, each post having a post end face, and
lands that correspond to portions of the collar end surface that are disposed between the posts,
the slot includes
a first slot portion that permits pin travel between a first location of the collar and a second location of the collar where the second location of the collar is closer to the collar first end than the first location of the collar,
a second slot portion that permits pin travel between the second location of the collar and a third location of the collar,
a third slot portion that permits pin travel between the third location of the collar and a fourth location of the collar where the third location of the collar is closer to the collar first end than the fourth location of the collar and where the first location of the collar is closer to the collar first end than the fourth location of the collar, and
when the pin is in the first slot portion, the mandrel clamping element is aligned with the posts, when the pin is in the second slot portion, the mandrel clamping element is aligned with the lands and the sprint urges the mandrel clamping element toward the lands.

5. The mandrel assembly of claim 4, wherein
when the pin is at the first location of the collar, the mandrel clamping element is aligned with the posts and abuts the end faces of the posts,
when the pin is pin is at the second location of the collar, the mandrel clamping element is aligned with the posts and is axially spaced relative to the posts,
when the pin is at the third location of the collar, the mandrel clamping element is aligned with the lands and is axially spaced apart relative to the lands, and
when the pin is at the fourth location of the collar, the mandrel clamping element is aligned with the lands and abuts the lands.

6. The mandrel assembly of claim 4, wherein the third location of the collar is spaced apart from the second location of the collar along a circumferential direction of the collar, and when the pin is in the third slot portion, the mandrel is rotatable relative to the collar about the longitudinal axis.

7. The mandrel assembly of claim 4, wherein
the first slot portion is linear and extends in a direction parallel to the longitudinal axis,
the second slot portion is linear and extends in a direction parallel to the longitudinal axis, the second slot portion being spaced apart from the first slot portion along a circumference of the collar, and
the third slot portion is linear and extends in a direction perpendicular to the longitudinal axis.

8. The mandrel assembly of claim 4, wherein the third slot portion extends along an arc length of ninety degrees.

9. The mandrel assembly of claim 4, wherein the third slot portion extends along an arc length of less than 10 degrees.

10. The mandrel assembly of claim 4, wherein
the first slot portion and the second slot portion are arcuate.

11. The mandrel assembly of claim 4, wherein upon an axial relative movement between the collar and the mandrel, the slot is configured to permit the mandrel to automatically move relative to the collar between a first position in which the mandrel clamping element is aligned with and abutting the end faces of the posts, and a second position in which the mandrel clamping element is aligned with the lands and urged toward the lands via the spring.

12. The mandrel assembly of claim 1, wherein relative movement between the collar and the mandrel in a direction parallel to the longitudinal axis results in rotation of the mandrel about the longitudinal axis.

13. The mandrel assembly of claim 1, wherein the slot extends through a thickness of the sidewall.

14. The mandrel assembly of claim 1, wherein the mandrel clamping element comprises a plate that extends in a plane that is perpendicular to the longitudinal axis, the plate having an irregular profile that defines a central hub and pair of arms that protrude from opposite sides of the hub.

15. A mandrel assembly, comprising:
a collar including
a collar first end,
a collar second end that is opposite the first end, and
a sidewall that extends between the collar first end and the collar second end, the sidewall including an inner surface that defines a bore, the bore opening at the collar first end and the collar second end, the bore having a step change in diameter that defines a shoulder, the sidewall including a slot that is spaced apart from the collar first end and the collar second end;
a mandrel disposed in the bore, the mandrel including
a mandrel first end that protrudes from the collar first end, the mandrel first end having a mandrel clamping element,
a mandrel second end that is opposite the mandrel first end, the mandrel second end protruding from the collar second end,
a longitudinal axis that extends through the mandrel first end and the mandrel second end, and
a pin disposed between the mandrel first end and the mandrel second end, the pin protruding from the mandrel in a direction perpendicular to the longitudinal axis and extending into the slot;
a retention washer disposed on the mandrel between the pin and the mandrel second end; and
a spring that surrounds the mandrel, the spring extending between the retention washer and the shoulder,
wherein
the collar first end includes
a collar end surface,
posts that protrude from the collar end surface in a direction parallel to the longitudinal axis, each post having a post end face, and
lands corresponding to portions of the collar end surface disposed between the posts, and
the slot is configured to permit the mandrel to move relative to the collar between an insertion position in which the mandrel clamping element is aligned with and abutting the end faces of the posts, and a clamping position in which the mandrel clamping element is aligned with the lands and the lands are urged toward the clamping element via the spring.

16. The mandrel assembly of claim 15, comprising an accessory configured to be connected to the mandrel assembly, the accessory including a body having a central opening, wherein the central opening has a profile, and at least a portion of the profile has a shape and dimensions that correspond to the shape, dimensions and spacing of the posts such that the collar first end can be inserted into the central opening in a tolerance fit.

17. The mandrel assembly of claim 15, comprising an accessory configured to be connected to the mandrel assembly, wherein a portion of the accessory is clamped between the lands and the mandrel clamping element.

18. The mandrel assembly of claim 15, comprising an accessory configured to be connected to the mandrel assembly, wherein
the mandrel clamping element comprises a plate that extends in a plane that is perpendicular to the longitudinal axis, the plate having an irregular profile that defines a central hub and arms that protrude from opposite sides of the hub, and
a portion of the accessory is clamped between the lands of the collar and the arms of the mandrel clamping element.
